(19) United States
(12) Patent Application Publication
(10) Pub. No.: US 2006/0126270 A1
(43) Pub. Date: Jun. 15, 2006

(54) Electrical dual layer capacitor

(75) Inventor: Satoru Yoshimitsu, Saga-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: Sanyo Electric Co., Ltd., Moriguchi-shi (JP); Saga Sanyo Industries Co., Ltd., Saga (JP)

(21) Appl. No.: 11/298,513

(22) Filed: Dec. 12, 2005

(30) Foreign Application Priority Data
Dec. 15, 2004 (JP) 2004-362598(P)

(51) Int. Cl. H01G 9/02

(52) U.S. Cl. 361/504

(57) ABSTRACT

An electrical dual layer capacitor including a separator, a pair of polarized electrodes sandwiching the separator, and an electrolyte with which the separator and the polarized electrodes are impregnated, characterized in that the electrolyte contains tetraalkylammoniumoxalatoborate. The electrolyte can contain the tetraalkylammoniumoxalatoborate in an amount of 0.8-1.5 mole/liter. Furthermore, the tetraalkylammoniumoxalatoborate can be one of tetramethylammoniumoxalatoborate and tetraethylammoniumoxalatoborate. An electrical dual layer capacitor significantly safe and low in internal resistance can thus be provided.

### BACKGROUND OF THE INVENTION

1. Field of the Invention

The present invention relates generally to electrical dual layer capacitors and particularly to electrical dual layer capacitors providing increased safety and reduced internal resistance.

2. Description of the Background Art

An electrical dual layer capacitor is a capacitor having a polarized electrode formed of a porous carbon material and impregnated with electrolyte to utilize electrostatic capacity of an electrical dual layer provided at an interface of the electrode and the electrolyte. While such electrical dual layer capacitor provides a rated voltage of as low as several volts, it can readily provide a large electrostatic capacity of farad order. Accordingly it is increasingly used as a backup power supply for dynamic random access memory (DRAM) and similar semiconductor devices, a backup power supply used in starting a motor, and the like.

A conventional electrical dual layer capacitor employs an electrolyte of an organic solution containing tetraethylammoniumfluoroborate or a similar borofluoride (see Japanese Patent Laying-open Nos. 11-307404 and 2000-182903 for example). The above borofluoride, however, has a nature generating hydrogen fluoride (HF) when the borofluoride reacts with water in the atmosphere, and if the sealing of the electrolyte in the capacitor is broken by mechanical rapture or electrochemical lord there is a possibility that the electrolyte leaks from the capacitor and reacts with water in the atmosphere to generate hydrogen fluoride. Furthermore, such electrolyte is relatively low in electrical conductance, and the capacitor is disadvantageously increased in internal resistance.

There is a need for an electrical dual layer capacitor safer and lower in internal resistance than conventional electrical dual layer capacitors.

### SUMMARY OF THE INVENTION

The present invention contemplates an electrical dual layer capacitor that can provide increased safety and reduced internal resistance.

The present invention is an electrical dual layer capacitor including a separator, a pair of polarized electrodes sandwiching the separator, and an electrolyte with which the separator and the polarized electrodes are impregnated, characterized in that the electrolyte contains tetraalkylammoniumoxalatoborate.

In the present electrical dual layer capacitor the electrolyte can contain the tetraalkylammoniumoxalatoborate in an amount of 0.8-1.5 mole/liter. Furthermore, the tetraalkylammoniumoxalatoborate can be one of tetramethylammoniumoxalatoborate and tetraethylammoniumoxalatoborate. Furthermore, at least one of the separator and the pair of polarized electrodes can be formed of a porous material.

Thus the present invention can provide an electrical dual layer capacitor that allows increased safety and reduced internal resistance

The foregoing and other objects, features, aspects and advantages of the present invention will become more apparent from the following detailed description of the present invention when taken in conjunction with the accompanying drawing.

### BRIEF DESCRIPTION OF THE DRAWINGS

FIG. 1 is a schematic cross section of the present electrical dual layer capacitor.

### DESCRIPTION OF THE PREFERRED EMBODIMENTS

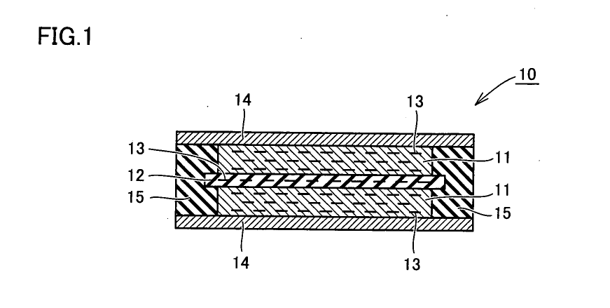

With reference to FIG. 1 the present invention provides an electrical dual layer capacitor 10 including a separator 12, a pair of polarized electrodes 11 sandwiching separator 12, and an electrolyte 13 with which separator 12 and polarized electrodes 11 are impregnated and which contains tetraalkylammoniumoxalatoborate.

More specifically, with reference to FIG. 1, electrical dual layer capacitor 10 has separator 12 having opposite sides, each opposite polarized electrode 11, and separator 12 and polarized electrodes 11 are impregnated with electrolyte 13 containing tetraalkylammoniumoxalatoborate. Furthermore, separator 12, polarized electrodes 11 and electrolyte 13 are sealed by a pair of collector electrodes 14 and a sealant 15.

The above tetraalkylammoniumoxalatoborate is a chemically more stable compound than the above mentioned borofluoride. It does not react with water in the atmosphere. As such, it does not generate hydrogen fluoride. Furthermore, the electrolyte containing tetraalkylammoniumoxalatoborate is higher in electrical conductance than that containing a borofluoride equal in molarity and can thus reduce the electrical dual layer capacitor in internal resistance.

Herein tetraalkylammoniumoxalatoborate refers to a compound represented by the following chemical formula (1): 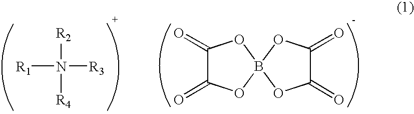
wherein R₁, R₂, R₃ and R₄ represent alkyl groups having equal or different carbon numbers, which are preferably, but not limited to, at most four, more preferably at most two to provide increased solubility in the solvent. For example, tetraalkylammoniumoxalatoborate is particularly preferably tetramethylammoniumoxalatoborate, tetraethylammoniumoxalatoborate, and the like.

The electrolyte can contain tetraalkylammoniumoxalatoborate in any amount. Preferably, however, the electrolyte contains 0.8-1.5 mole/liter thereof. A tetraalkylammoniumoxalatoborate content of less than 0.8 mole/liter decreases the electrolyte in electrical conductance and increases the electrical dual layer capacitor in internal resistance, and thus impairs the capacitor in practical usability. A tetraalkylammoniumoxalatoborate content exceeding 1.5 mole/liter provides reduced solubility in the solvent.

The electrolyte may have tetraalkylammoniumoxalatoborate solved in any solvent. Preferably, however, the electrolyte has the borate solved in at least one organic solvent selected from carbonates, alcohols, nitrites, amides and ethers to help to solve the borate and increase the electrolyte in electrical conductance. Note that the carbonates include propylene carbonate, ethylene carbonate, butylene carbonate, and the like. The alcohols include ethanol, methanol, propanol and the like. The nitriles include acetonitrile and the like. The amides include dimethylformamide and the like. The ethers include diethylether and the like.

The polarized electrode may be any that is electrically conductive. Preferably, however, it is formed of a porous material providing a large specific surface area to increase the electrical dual layer capacitor in electrostatic capacity. For example, a porous material implemented by granular activated carbon or activated carbon fiber, and a conductive material serving as a conductive carbon binder implemented by a high-molecular compound can be mixed together to obtain a suitable polarized electrode. The conductive carbon includes carbon black, ketchen black, and the like. The high-molecular compound preferably includes polytetrafluoroethylene, polyvinylidenefluoride and similar fluoric high molecules to provide high durability against the electrolyte.

The separator may be formed of any material that is electrochemically stable and able to prevent the polarized electrodes from electrical short circuit. Suitably, however, it is formed of nonwoven fabric, or porous polypropylene film, polyethylene film, cellulose film or other similar porous material to provide high ionic permeability and large mechanical strength.

The collector electrode may be any that is electrically connectable to the polarized electrode. Preferably, however, it is formed of aluminum foil, foamed nickel foil or the like to provide significant durability against the electrolyte. Furthermore the sealant may be any sealant that can provide insulation against the polarized and collector electrodes.

With reference to FIG. 1, the electrical dual layer capacitor can be fabricated as follows: Initially a porous material implemented by activated carbon, a conductive material implemented by carbon black, and a binder implemented by a high-molecular compound are mixed together to provide polarized electrode 11. A pair of such polarized electrodes 11 is then arranged to sandwich separator 12 formed of a porous high-molecular compound material to provide an internal element, which is in turn immersed in an electrolyte containing tetraalkylammoniumoxalatoborate at a prescribed concentration, and thereafter the internal element is sealed by a pair of collector electrodes 14 and sealant 15.

### FIRST EXAMPLE

With reference to FIG. 1, a porous material implemented by activated carbon, a conductive material implemented by carbon black, and a binder implemented by polytetrafluoroethylene were mixed together at a ratio in mass of 8:1:1 to provide polarized electrode 11 having a diameter of 15 mm and a thickness of 0.6 mm. The activated carbon was that undergoing an alkaline activation process and having a specific surface area of 2,300 m²/g, as measured by the Brunauer Emmett Teller (BET) method, and a total amount of acidic group of 1.5 millimole/m², as measured by vapor phase neutralization. Separator 12 was formed of nonwoven cellulose fabric having a diameter of 25 mm and a thickness of 50 μm. The two polarized electrodes 11 and separator 12 were immersed in and thus impregnated with an electrolyte implemented by a propylene carbonate solution containing one mole/liter of tetramethylammoniumoxalatoborate having a chemical structure, as represented by the following chemical formula (2): 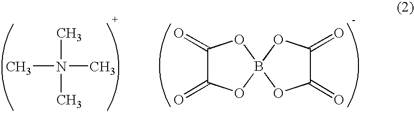
In a table 1 this solution is indicated as 1M-TMAOB/PC.

The pair of electrolyte impregnated polarized electrodes 11 was arranged to sandwich the electrolyte impregnated separator 12 to provide an internal element, which was in turn sealed by a pair of collector electrodes 14 formed of etched aluminum foil and having a diameter of 15 mm and a thickness of 100 μm and sealant 15 provided in the form of a cylinder having an inner diameter of 12.5 mm, an outer diameter of 15 mm and a height of 3.5 mm to form an electrical dual layer capacitor in the form of a coin having a diameter of 15 mm, a thickness of 3.2 mm and a weight of 0.5 g.

The obtained capacitor was caused to charge and discharge a constant current for a current density of 10 mA per a unit mass (of one gram) of the polarized electrode used to obtain direct current (dc) electrostatic capacity (F) and internal resistance (Ω) from a discharge curve provided as charged with a constant voltage of 2.3 V to calculate electrostatic capacity (F) per the unit mass of the polarized electrode. The obtained electrical dual layer capacitor provided a unit electrostatic capacity of 138.2 F/g and an internal resistance of 7.6Ω, as indicated in table 1. Note that the obtained unit electrostatic capacity and internal resistance were an average for 20 such electrical dual layer capacitors.

### SECOND EXAMPLE

An electrical dual layer capacitor was fabricated in a manner similar to that of the first example, except that the electrolyte was a propylene carbonate solution containing one mole/liter of tetraethylammoniumoxalatoborate having a chemical structure, as presented by the following chemical formula (3): 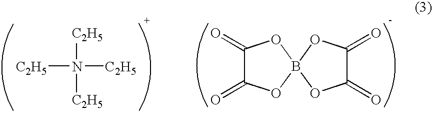
This solution is referred to in table 1 as 1M-TEAOB/PC. The obtained capacitor provided a unit electrostatic capacity of 141.5 F/g and an internal resistance of 7.2Ω, as indicated in table 1.

### FIRST COMPARATIVE EXAMPLE

An electrical dual layer capacitor was fabricated in a manner similar to that of the first example, except that the electrolyte was a propylene carbonate solution containing one mole/liter of tetraethylammoniumtetrafluoroborate having a chemical structure, as presented by the following chemical formula (4):

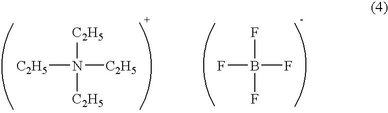

This solution is referred to in table 1 as 1M-TEATFB/PC. The obtained capacitor provided a unit electrostatic capacity of 131.3 F/g and an internal resistance of 11.1Ω, as indicated in table 1.

TABLE 1

| | | | Comparative |
|---|---|---|---|
| | Ex. 1 | Ex. 2 | Ex. 1 |
| electrolyte | 1M-TMAOB/ | 1M-TEAOB/ | 1M-TEATFB/ |
| | PC | PC | PC |
| unit electrostatic | 138.2 | 141.5 | 131.3 |
| capacity (F/g) | | | |
| internal | 7.6 | 7.2 | 11.1 |
| resistance (Ω) | | | |

It is apparent from table 1 that the electrical dual layer capacitor employing an electrolyte containing tetraalkylammoniumoxalatoborate can provide larger electrostatic capacity and significantly smaller internal resistance than conventional electrical dual layer capacitors.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electrical dual layer capacitor comprising a separator, a pair of polarized electrodes sandwiching said separator, and an electrolyte with which said separator and said polarized electrodes are impregnated, characterized in that said electrolyte contains tetraalkylammoniumoxalatoborate.

2. The electrical dual layer capacitor according to claim 1, wherein said electrolyte contains said tetraalkylammoniumoxalatoborate in an amount of 0.8-1.5 mole/liter.

3. The electrical dual layer capacitor according to claim 2, wherein said tetraalkylammoniumoxalatoborate is one of tetramethylammoniumoxalatoborate and tetraethylammoniumoxalatoborate.

4. The electrical dual layer capacitor according to claim 2, wherein at least one of said separator and said pair of polarized electrodes is formed of a porous material.

5. The electrical dual layer capacitor according to claim 1, wherein said tetraalkylammoniumoxalatoborate is one of tetramethylammoniumoxalatoborate and tetraethylammoniumoxalatoborate.

6. The electrical dual layer capacitor according to claim 5, wherein at least one of said separator and said pair of polarized electrodes is formed of a porous material.

7. The electrical dual layer capacitor according to claim 1, wherein at least one of said separator and said pair of polarized electrodes is formed of a porous material.
